(19) United States
(12) Patent Application Publication
(10) Pub. No.: US 2014/0139325 A1
(43) Pub. Date: May 22, 2014

(54) PROCESS AND DEVICE FOR THE TRANSFER OF SIGNALS

(71) Applicant: Hella KGaA Hueck & Co., Lippstadt (DE)

(72) Inventors: Jürgen Griebel, Maulburg (DE); Andreas Haas, Rheinfelden (DE); Peter Ruppert, Lorrach (DE)

(21) Appl. No.: 14/078,244

(22) Filed: Nov. 12, 2013

(30) Foreign Application Priority Data
Nov. 13, 2012 (DE) 102012220601.9

(51) Int. Cl. G08C 19/16; B60Q 1/00; B60Q 3/00; H05B 37/02

(52) U.S. Cl. CPC G08C 19/16; H05B 37/02; B60Q 1/00; B60Q 3/00
USPC 340/12.16; 315/246; 315/77

(57) ABSTRACT

A process for transfer of signals is provided between a first control unit and at least a second control unit, wherein the first control unit, based on the input data, selects at least a first signal that is to be transferred, and the first control unit has at least one signal output, at which a first PWM signal can be emitted, wherein a first PWM signal is encoded and assigned to each selected at least one first signal, and wherein the second control device has one first signal input, which receives the first PWM signal and the second control device evaluates the first PWM signal received and detects the first signal and, based on the first signal transferred, creates a subsequent control instruction. A related device is also disclosed.

### CROSS REFERENCE

This application claims priority to German Patent Application No. 10 2012 220601.9, filed Nov. 13, 2012.

### TECHNICAL FIELD OF THE INVENTION

The invention concerns a method and a device for the transfer of signals, particularly for setting lighting scenarios.

### BACKGROUND OF THE INVENTION

In modern automobiles there are various control devices, some of which communicate with one another. In general, the process uses a data bus, such as a CAN bus or LIN bus, by means of which a number of control devices can send signals to the data bus or receive signals from the data bus in order to use them for further control processes.

However, the provision of the data-bus interface is expensive, which means that not every control device has such a data-bus interface. It is equally difficult to retrofit this data-bus interface accordingly in platform-independent control devices that are used in automobiles, since these control devices are used identically via the platforms and differentiating the control device with and without the data-bus interface increases the logistical effort. On the other hand, the implementation of a data-bus interface would lead to unnecessary costs, since a proportion of the control devices are installed in vehicles that do not require this data-bus interface, even if the control device were to be provided with the data-bus interface. Thus, a proportion of the control devices would be fitted with superfluous functionality, which would mean unnecessary costs.

### SUMMARY OF THE INVENTION

Thus the object of the present invention is to create a process and a device for transferring signals that can be used particularly for setting up lighting scenarios and that transmits a plurality of different signals and that can be implemented without a data-bus interface between the control devices concerned.

An exemplary embodiment of the invention concerns a process for the transfer of signals between a first control unit and at least one second control unit, wherein the first control unit, based on the input data, selects at least one first signal that is to be transferred, and the first control device has at least one signal output, to which one first PWM signal can be output, wherein at least one first PWM signal is encoded and assigned to each selected signal, and wherein the second control device has one first signal input, which receives the first PWM signal and the second control device evaluates the first PWM signal received and detects the first signal, and creates a subsequent control instruction based on the first transferred signal. In this manner, communication can be conducted, even without a data bus, where PWM outputs and PWM inputs are available, which can be implemented at low cost.

It is also expedient if the first control device generates at least one second PWM signal and can output at least one second signal output, and the second control device has at least one second signal input for receiving the at least second PWM signal. By using two PWM signals or even more than two PWM signals, greater selection of data can be transferred since several definable codes are available.

In this respect, it is expedient if the first control device, based on the input data, also selects at least one second signal, which can be transferred by the at least first PWM signal or the first and at least second PWM signal.

It is also advantageous if the first and/or second, and, if applicable, further PWM signals can be modulated in the pulse width between a lower limit and an upper limit in steps with a predefinable step width. The number of codes that can be transferred can be determined by the choice of the upper and the lower limit and the step width.

The number of possible codes is restricted by the definition of the lower limit, such that it is advantageous if the lower limit is 2%, 5% 10% or a multiple of 2% or 5%.

The number of possible codes is also restricted by the definition of the upper limit, which means that it is advantageous if the upper limit is 90%, 95%, 98% or a multiple of 2% or 5%, wherein the upper limit is greater than the lower limit.

In this respect, it is particularly advantageous if the step width is 2%, 5% or a multiple of 2% or 5%. In this way, a useful step width can be defined that can also be resolved.

In this respect, it is particularly advantageous if there is a unique assignment to the PWM signal or to the PWM signals for the first signal to be transferred, and, if applicable, for the further signals to be transferred. In this way, for example, there can be a fixed specification for the definition of the signals. Thus, a simple transfer can be implemented with simple identification.

In this respect, it is also advantageous if a change from one signal to a subsequent signal is recognized and carried out by the second control unit if the subsequent signal is present for at least a predeterminable number of PWM cycles. In this respect, the predefinable number is 3 or more, for example. If a signal is output as specified, it is controlled accordingly. If there is then a changeover to a new subsequent signal, this signal must first be detected for the specified number of times in order to be controlled as a new signal.

In this respect, it is expedient if the predefinable number is 2, 3, 4, 5 or a higher integer. This ensures that a one-time error does not lead to a change in the control instruction.

In this respect, it can be expedient if the at least one PWM signal is continuously emitted. All PWM signals may also be continuously emitted. In certain configurations, this is easier than temporarily switching off.

It is also expedient if the at least one PWM signal is only emitted if a new subsequent signal is emitted, wherein the output continues for long enough for the new subsequent signal to be recognized by the second control device.

Moreover, it is advantageous if the signal represents a lighting scenario and/or a light intensity and/or a lighting color.

In this respect, it is particularly advantageous if, for a transfer by means of two PWM signals, a first PWM signal represents a lighting scenario and a second PWM signal represents a color. Alternatively, a plurality of lighting scenarios and colors may be encoded by means of both PWM signals.

It is also advantageous if, for a transfer by means of three PWM signals, a first PWM signal represents a lighting scenario and a second and a third PWM signal represents a color.

Similarly, it is also possible if, for a transfer by means of three PWM signals, a first PWM signal represents a lighting scenario and a second PWM signal represents a color and a third PWM signal represent a light intensity.

It is also expedient if, for a transfer by means of at least two PWM signals, at least a first PWM signal specifies which signal is transferred and at least a second PWM signal specifies which value or status the signal assumes.

Moreover, it is expedient if, for a transfer by means of at least at least oneor more PWM signals, a numerical code is transferred, wherein at least a first PWM signal specifies the position of the numerical code and/or, if required, at least one second PWM signal specifies the value of the position of the numerical code.

An exemplary embodiment of the invention relates to a device for transfer of signals between one first control unit and at least one second control unit, with a first control unit and with a second control unit, wherein the first control unit, based on the input data, selects at least one signal at a data input that is to be transferred, and the first control device has at least one signal output, at which at least one first PWM signal can be output, wherein a first PWM signal is encoded and assigned to each of the selected at least one first signals, and wherein the second control device has a first signal input, which receives the first PWM signal and the second control device evaluates the first PWM signal received and detects the first signal and, based on the first transferred signal, creates a subsequent control instruction.

In this respect, it is advantageous if the data input receives input data from an input device. In this respect, the input device may be a rotary knob, a touch-sensitive surface or an appropriate screen or similar.

It is also advantageous if one lighting device is controlled by the second control device. In this respect, an example of the first control device may be an onboard control device, which receives the appropriate signal from the input device. An example of the second control device may be a control device for the lighting control.

In this respect, it is also expedient if the scope of the lighting device includes the lighting of the interior of the vehicle, of the instrument panel, of one door and the vehicle interior roof, etc.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 a schematic representation of a device for transferring signals,

FIG. 2 an explanatory diagram for the invention,

FIG. 3 an explanatory diagram for the invention,

FIG. 4 an explanatory diagram for the invention, and

FIG. 5 an explanatory diagram for the invention.

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

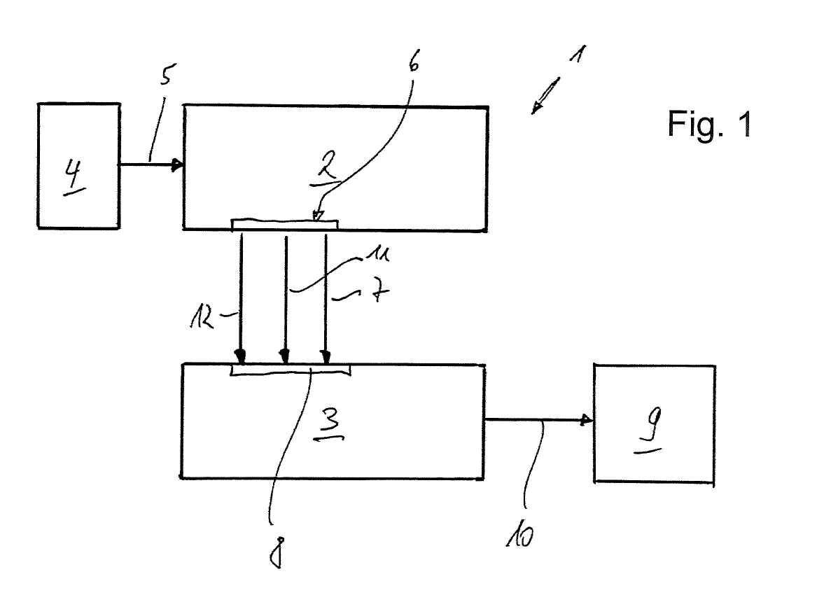

FIG. 1 illustrates a device for transfer of signals between a first control unit 2 and a second control unit 3. In this respect, the first control unit 2 has a signal connection with an input unit 4. By means of the input unit 4, a user can make an input, for example, wherein the input data of the input unit 4 are used as input data 5 of the first control unit 2. Alternatively, instead of an input unit operated by a user, an input can also be made by means of an electronic control unit, wherein input data are generated that are to be transferred.

The first control unit 2 detects from the input data a first signal that is to be transferred, wherein the first control unit 2 generates at least one first PWM signal 7 via a signal output 6 that is output through the signal output 6. The at least first PWM signal 7 is received by the second control unit 3 by means of a signal input 8 of the second control unit 3, and the second control unit 3 evaluates the at least first PWM signal 7 in order to subsequently create a control instruction for a further device 9. For this purpose, an output signal 10 is generated, which is transferred to the device 9.

Alternatively, in addition to the first PWM signal 7, a second PWM signal 11 and/or a third PWM signal 12 can also be transferred from the first control unit 2 to the second control unit 3.

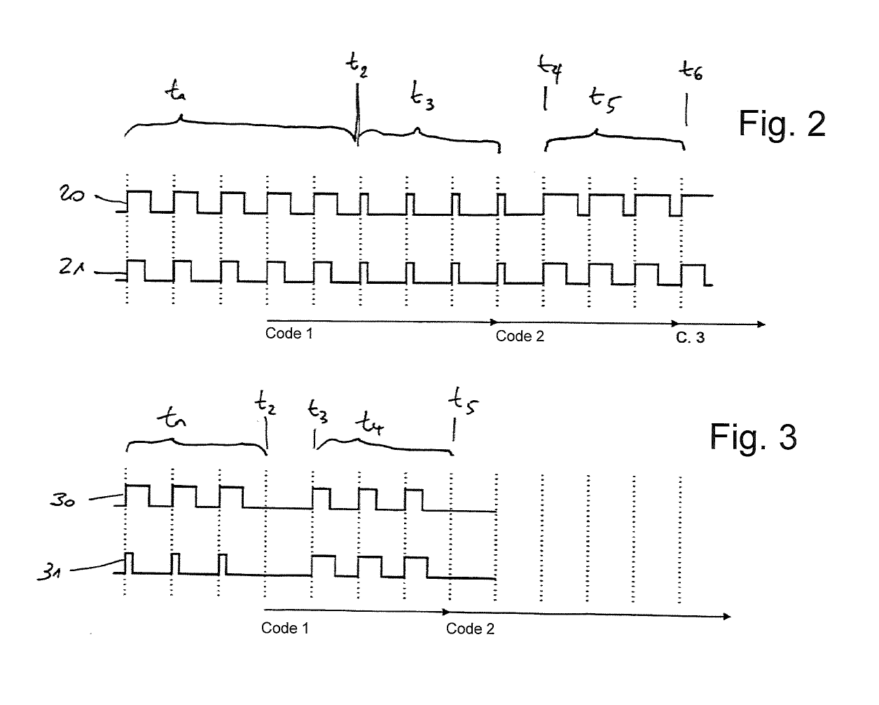

FIG. 2 illustrates two PWM signals 20 and 21, represented as functions of time, which are transferred from the first control unit 2 to the second control unit 3. In the time interval t1, two PWM signals 20 and 21 are transferred, each with a fixed pulse width. These two PWM signals 20 and 21 in this time frame stand for a code 1 that is transferred and that is also controlled by the second control unit 3. Starting from time t2, there is a change in the pulse width of the first PWM signal 20 and the second PWM signal 21, wherein the associated code 2 is only acknowledged and controlled after the transfer of three cycles. This means that after the time period t3 has elapsed, code 2 according to the PWM signals 20 and 21 is controlled during the time period t3. Starting from the time point t4, in turn, the pulse widths of the PWM signals 20 and 21 are changed such that after the transfer of three cycles over the time period t5, starting from time point t6, code 3 according to the PWM signals 20 and 21 is valid for being controlled during the time interval t5. It can be seen that the PWM signals 20 and 21 in FIG. 2 are emitted as continuous PWM signals, which are also emitted if there is no change in the pulse width or the duty cycle (mark-space ratio).

FIG. 3 illustrates another exemplary embodiment in which, in turn, two PWM signals 30 and 31 are represented with respect to time. At the beginning, three cycles over the time period t1 are shown, wherein, starting from time point t2, the code 1 corresponding to the PWM signals 30 and 31 is controlled in the time period t1. From time point t2 to time point t3 there is no signal output, since there is no change in the input data or the signals to be transferred.

Starting only from time point t3 are the PWM signals 30 and 31 emitted once again with changed pulse width, so that the PWM signals 30 and 31 are emitted over the time period t4 and, starting from the time point t5, code 2 corresponding to PWM signals 30 and 31 is controlled during the time period t4. Starting from the time period t5, there is also no further output of the PWM signals, since code 2 is valid for being controlled starting from this time point.

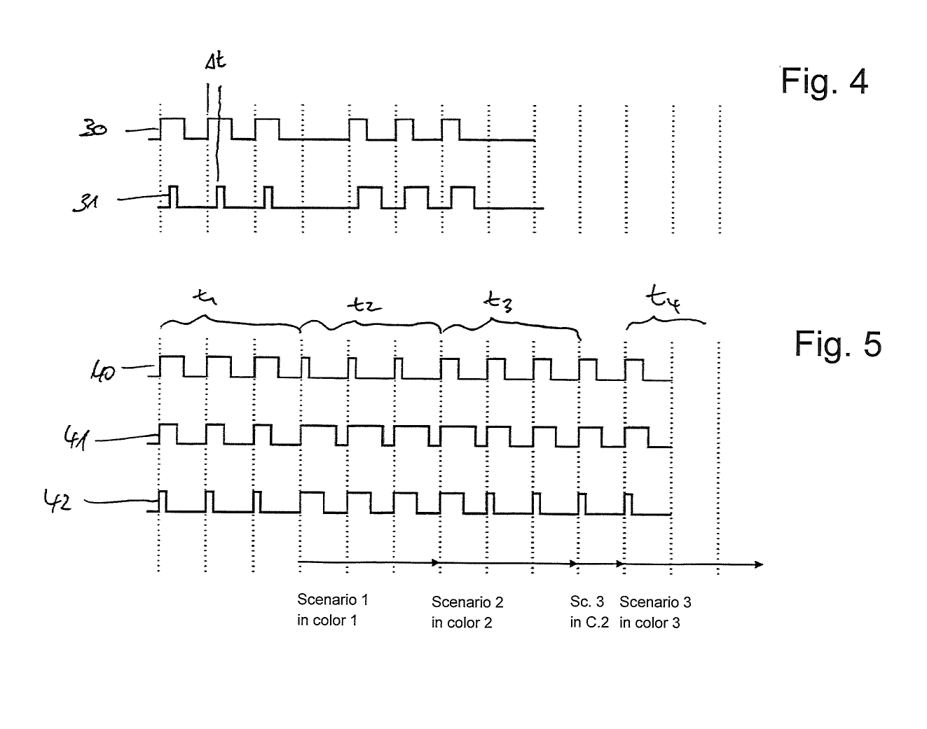

FIG. 4 illustrates the sequence of PWM signals corresponding to FIG. 3, wherein the two PWM signals 30 and 31 are not transferred synchronously, but instead PWM signal 31 has a phase offset with respect to PWM signal 30. However, since the duty cycle (mark-space ratio) is measured rather than the edges, that is, the pulse width is evaluated, the offset of Δt between the rising edges of signal 30 and signal 31 does not jeopardize the process according to the invention and is thus permissible.

FIG. 5 illustrates how a signal transfer can take place with three PWM signals 40, 41 and 42 as continuous PWM signals. Thus, for example, the PWM signal 40 encodes a lighting scenario, and the two PWM signals 41 and 42 together encode a number, which is assigned to a corresponding color in the second control unit. Accordingly, for the first signal transfer during the time period t1 there is a selection of scenario 1 in color 1; for the time period t2, the signal transfer specifies scenario 2 in color 2; next, for the time period t3, the signal transfer specifies scenario 3 in color 2 and, starting from time t4, the transfer of signals is for scenario 3 in color 3.

FIG. 2 illustrates the changing of three codes over time that, for example, can be used to change a lighting scenario, a lighting color or also a light intensity. Encoding by the two PWM signals 20 and 21 occurs by changing the pulse width, wherein a change in the pulse width takes place in accordance with an input made via the input unit. In this respect, each combination of PWM signals 20 and 21 determines a code by means of their pulse widths, wherein this code is saved in the second control unit 3, receiving these signals and appropriate control instruction for the subsequent devices can be created.

In the exemplary embodiments in FIGS. 2 to 5, the PWM signal transferred is accepted and changed only if the same pulse width is detected for the respective PWM signals during three successive cycles, for example. This has the advantage that transfer errors do not lead to immediate change in the control, but instead, changeover from one code to another takes place only if the change of the transferred signal can be attributed with a certain likelihood to an input made by means of the input unit or some other control of the input signal. To enhance the certainty, the number of cycles can also be increased in which the same PWM signals would have to be detected in order to be accepted as a new signal for another code. This safety measure may also be dispensed with if the likelihood of transfer errors is low. In this respect, the number of cycles, during which the same signal would have to be detected, in order to evaluate a signal as being transferred and acknowledged, can be a number between one and an integer greater than one, in other words, 1, 2, 3, 4, 5 etc.

In the exemplary embodiments illustrated in FIGS. 2 to 5, the pulse width or the duty cycle (mark-space ratio) is designed in such a manner that, for example, the respective pulse widths can be increased in two per cent steps or five per cent steps. In this respect, a lower limit of, for example, 10% and an upper limit of, for example, 98% can be used. With a step width of 2%, it would be possible to transmit a plurality of 2025 states. Accordingly, the encoding could transmit a plurality of 2,025 states. With a step width of 5% between a lower and an upper limit of 10% and 95%, respectively, 18×18=324 different states could still be transferred.

For the exemplary embodiment in FIG. 5, for example, the signal is encoded in steps of 5%. In this case, for example, transfer errors may not be permissible. The PWM signals 41 and 42, for the color, for example, may also be transferred in smaller steps of 0.5%, for example. In this respect, a small transfer error due to measurement inaccuracy may be permissible; however, this should not have a visible impact. For example, the ratio of signals 41 and 42 can be used as a value for the color.

As another variant, the first PWM signal can determine what is transferred via another PWM signal, such as the second and/or third PWM signal. The second PWM signal then transmits its corresponding value simultaneously. An example of this is the color red encoded on PWM signal 1 by a 5% duty cycle (mark-space ratio) or pulse width. The color green is encoded by a 10% duty cycle (mark-space ratio) or pulse width. The color blue is encoded by a 15% duty cycle (mark-space ratio) or pulse width. A lighting scenario is encoded by a 20% duty cycle (mark-space ratio) or pulse width and the light intensity is encoded by a 25% duty cycle (mark-space ratio) or pulse width. Signal 2 would then control the color red with 5%, the color green with 10% and the color blue with 15%. With a 20% signal for the scenario according to signal 1, a 10% signal for signal 2 could signify scenario 2, for example. With 25% for signal 1 corresponding to the light intensity, a 5% pulse width could signify 5% light intensity.

The PWM signals for the second signal for the colors red, green and blue may also be encoded in percentage values, so that with signal 2 for the color red, for example, a 5% signal can be evaluated as 5% red. This can be done accordingly for the colors green and blue.

Alternatively, the first PWM signal can also be encoded in pulse-width steps of 5%, wherein, for example, the first PWM signal is defined as a digit of a number. Thus, for example, the units digit would be encoded at 5%, the tens digit encoded at 10%, the hundreds digit encoded at 15%, etc. The second PWM signal would then encode the number itself in steps of 5%. Thus there can be a serial transfer of 5, for example, for position 1, 3, for example, for position 2, and 4, for example, for position 3, which would signify color number 435. Accordingly, by applying the PWM signals, encoded signals can be transferred that could be decoded by the receiving second control unit in order to create an appropriate control instruction.

For example, the transfer of a specific lighting scenario as a function of another control instruction is possible. In this manner, a specific lighting scenario can be instructed as a function of the unlocking of the central locking system of the vehicle. A specific lighting scenario can also be instructed when opening a door. A specific lighting scenario can also be instructed when starting and/or when switching off the engine of the vehicle.

It is also advantageous if these situation-specific scenarios can be individually selected or set.

The preferred embodiments of the invention have been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

### LIST OF REFERENCE SIGNS

1 Transfer device
2 First control unit
3 Second control unit
4 Input unit
5 Input signal
6 Signal output
7 PWM signal
8 Signal input
9 Device to be controlled
10 Output signal
11 PWM signal
12 PWM signal
20 PWM signal
21 PWM signal
30 PWM signal
31 PWM signal
40 PWM signal
41 PWM signal
42 PWM signal

1. A process for transfer of signals between a first control unit and at least a second control unit, comprising the steps of:
the first control unit, based on the input data, selects at least a first signal that is to be transferred, and the first control unit has at least one signal output, at which a first PWM signal can be emitted,
wherein a first PWM signal is encoded and assigned to each selected at least one first signal, and
wherein the second control device has one first signal input, which receives the first PWM signal and the second control device evaluates the first PWM signal received and detects the first signal and, based on the first signal transferred, creates a subsequent control instruction.

2. The process according to claim 1, wherein the first control device generates at least one second PWM signal and sends it to the signal output, and the second control device has the signal input for receiving the at least second PWM signal.

3. The process according to claim 2, wherein the first control unit, based on the input data, also selects at least a second signal, which can be transferred by one of the at least first PWM signal or by the at least second PWM signal.

4. The process according to claim 2, wherein at least one of the first or the second, PWM signals can be modulated with respect to the pulse width between a lower limit and an upper limit in steps of a predeterminable step width.

5. The process according to claim 4, wherein the lower limit is selected from the group consisting of 2%, 5% 10% and a multiple of 2% or 5%.

6. The process according to claim 4, wherein the upper limit is selected from the group consisting of 90%, 95%, 98% and a multiple of 2% or 5%, wherein the upper limit is greater than the lower limit.

7. The process according to claim 4, wherein the predeterminable step width is selected from the group consisting of 2%, 5% and a multiple of 2% or 5%.

8. The process according to claim 1, wherein for the first signal or other signals to be transferred, a unique assignment to one of the PWM signals occurs.

9. The process according to claim 1, wherein a change from one signal to a subsequent signal is acknowledged and carried out by the second control device if the subsequent signal is present for at least a predeterminable number of PWM cycles.

10. The process according to claim 9, wherein the predeterminable number an integer equal to or greater than 1.

11. The process according to claim 1, wherein the at least one PWM signal is continuously emitted.

12. The process according to claim 1, wherein at the least one PWM signal is only emitted if a new subsequent signal is emitted, wherein the emission continues long enough for the new subsequent signal to be recognized by the second control device.

13. The process according to claim 1, wherein the signal represents one of a lighting scenario, a light intensity, or a lighting color.

14. The process according to claim 13, wherein for a transfer by means of at least two PWM signals, a first PWM signal represents a lighting scenario, and an at least second PWM signal represents a color.

15. The process according to claim 13, wherein for transfer by means of three PWM signals, a first PWM signal represents a lighting scenario, and second and third PWM signals represent a color.

16. The process according to claim 13, wherein for transfer by means of three PWM signals, a first PWM signal represents a lighting scenario, a second PWM signal represents a color, and a third PWM signal represents a light intensity.

17. The process especially according to claim 1, wherein for transfer by means of at least two PWM signals, at least a first PWM signal specifies which signal is transferred, and an at least second PWM signal specifies which value or status the signal assumes.

18. The process according to claim 1, wherein for transfer by means of at least one or more PWM signals, a numerical code is transferred, wherein at least a first PWM signal specifies the position of the numerical code or at least a second PWM signal specifies the value of the position of the numerical code.

19. A device for transfer of signals, comprising
a first control unit and an at least second control unit, the first control unit being operable to, based on input data at a data input, to select at least a first signal that is to be transferred,
the first control device having at least one signal output, at which at least a first PWM signal can be emitted, wherein the first PWM signal is encoded and assigned to each selected signal, and
the second control device having a first signal input, which receives the first PWM signal and the second control device being further operable for evaluating the first PWM signal received and detecting the first signal, and, based on the first signal transferred, creating a subsequent control instruction.

20. The device according to claim 19, wherein the data input receives input data from an input unit.

21. The device according to claim 19, wherein a lighting device is controlled by the second control device.

22. The device according to claim 21, wherein the scope of the lighting device includes at least the lighting of the interior of the vehicle, of the instrument panel, of one door and the vehicle interior roof.
